(19) United States
(12) Patent Application Publication
(10) Pub. No.: US 2020/0065921 A1
(43) Pub. Date: Feb. 27, 2020

(54) System and Method for Prioritizing Maintenance and Repair of Building Roofs

(71) Applicant: Predictive Service , LLC, Cleveland, OH (US)

(72) Inventor: Shawn Goertzen, Cleveland, OH (US)

(73) Assignee: Predictive Service , LLC, Cleveland, OH (US)

(21) Appl. No.: 16/106,080

(22) Filed: Aug. 21, 2018

(51) Int. Cl. G06Q 50/16; G06F 17/30; G06Q 10/06; G06Q 10/00

(52) U.S. Cl. CPC G06Q 50/163; G06Q 10/20; G06Q 10/06316; G06F 17/3053

(57) ABSTRACT

A computer implemented method for prioritizing maintenance and repairs of building roofs includes the steps of electronically receiving total area and problem information associated with each of a plurality of building roofs, electronically calculating a condition ranking for each of the building roofs based at least partly on the total area and the problem information, and electronically providing the condition ranking for each of the building roofs to a user for viewing on an electronic display so that repair and maintenance of the roofs can be prioritized at least partly using the condition rankings. The problem information includes information regarding scope of problems and severity of problems. The condition ranking is preferably a numeric value within a predetermined range such as 1 to 10.

### CROSS-REFERENCE TO RELATED APPLICATIONS

Not Applicable

### STATEMENT REGARDING FEDERALLY SPONSORED RESEARCH

Not Applicable

### PARTIES TO A JOINT RESEARCH AGREEMENT

Not Applicable

### REFERENCE TO APPENDIX

Not Applicable

### FIELD OF THE INVENTION

The present invention generally relates to systems and methods for managing the maintenance and repair of building roofs and, more specifically, to systems and methods for prioritizing maintenance and repair of a plurality of building roofs.

### BACKGROUND OF THE INVENTION

Owners of facilities must make many decisions about maintenance and repair of their buildings including the roofs of their building. An owner may need to maintain and repair a large number of building roofs and some of these roofs can be large enough to have separate sections which can be individually maintained and repaired. As a result each building roof, and each section of a building roof, can have a different maintenance and repair history as well as different warranty terms. Decisions as to which roofs or sections of roofs should be repaired and/or the order in which they should be repaired can be complicated by what if anything is covered by warranty, limited budgets for maintenance and repair, and the possibility of tremendous negative financial impact when not adequately performing necessary maintenance and repairs. Owners of multiple facilities such as, for example, manufacturers, property and facility managers, hotels, school districts, universities, hospitals, service providers, contractors, utility authorities, and federal, state, municipalities and other local governments, have even more difficult decisions because of the volume of differing needs that must compete for repair and maintenance dollars.

Multi-location companies are typically inundated with many reports, most likely prepared by several different providers, with varied content and quality. With these varied reports, it is difficult to determine the true priorities among the problems, to determine which of the problems should be repaired first and when, to track progress of the problems over time by roof section and/or building location, and to know which roof sections and/or roofs are covered by warranties and which roof sections and/or roofs are not covered by warranties. Accordingly, there is a need in the art for improved systems and methods for prioritizing roof maintenance and repairs.

### SUMMARY OF THE INVENTION

Disclosed is a computer implemented method for prioritizing maintenance and repairs of building roofs. The disclosed method comprises the steps of electronically receiving total area and problem information associated with each of a plurality of building roofs; electronically calculating a condition ranking for each of the building roofs based at least partly on the total area and the problem information, and electronically providing the condition ranking for each of the building roofs to a user for viewing on an electronic display so that repair and maintenance of the roofs can be prioritized at least partly using the condition rankings. The problem information includes information regarding scope of problems and severity of problems and the condition ranking is a numeric value.

Also disclosed is a system for prioritizing maintenance and repairs of building roofs comprising a processor and memory configured to carry out the steps of electronically receiving total area and problem information associated with each of a plurality of building roofs, electronically calculating a condition ranking for each of the building roofs based at least partly on the total area and the problem information, and electronically providing the condition ranking for each of the building roofs to a user for viewing on an electronic display so that repair and maintenance of the roofs can be prioritized at least partly using the condition rankings. The problem information includes information regarding scope of problems and severity of problems and the condition ranking is a numeric value.

Also disclosed is c computer readable medium containing program instructions for electronically receiving total area and problem information associated with each of a plurality of building roofs, electronically calculating a condition ranking for each of the building roofs based at least partly on the total area and the problem information, and electronically providing the condition ranking for each of the building roofs to a user for viewing on an electronic display so that repair and maintenance of the roofs can be prioritized at least partly using the condition rankings. The problem information includes information regarding scope of problems and severity of problems and the condition ranking is a numeric value.

From the foregoing disclosure and the following more detailed description of various preferred embodiments it will be apparent to those skilled in the art that the present invention provides a significant advance in the technology and art of maintenance and repair systems and methods. Particularly significant in this regard is the potential the invention affords for providing consistent, accurate, and reliable results. Additional features and advantages of various preferred embodiments will be better understood in view of the detailed description provided below.

### BRIEF DESCRIPTION OF THE DRAWINGS

These and further features of the present invention will be apparent with reference to the following description and drawing, wherein:

FIG. 1 is a block diagram of a system for tracking and analyzing maintenance and repair of building roofs according to the present invention.

FIG. 1A is a block diagram of a service provider server of the system of FIG. 1.

FIG. 1B is a block diagram of a customer computer of the system of FIG. 1.

FIG. 2 is a screen shot of the system for tracking and analyzing maintenance and repair of building roofs of FIG. 1, wherein users can enter and view roof warranty information.

FIG. 3 is a screen shot of the system for prioritizing building roof repairs of FIG. 1, wherein information regarding a plurality of roofs can input, tracked, and viewed through a list view.

FIG. 4 is a screen shot of the system for prioritizing building roof repairs of FIG. 1, wherein inspection information can be entered, tracked, and viewed using a visual inspection entry form.

FIG. 5 is a screen shot of the system for prioritizing building roof repairs of FIG. 1, wherein visual inspection due dates and other roof information can be viewed from a site list showing a plurality of buildings for a single company.

### DETAILED DESCRIPTION OF CERTAIN PREFERRED EMBODIMENTS

It will be apparent to those skilled in the art, that is, to those who have knowledge or experience in this area of technology, that many uses and design variations are possible for the improved systems and methods for prioritizing building roof repairs disclosed herein. The following detailed discussion of various alternative and preferred embodiments will illustrate the general principles of the invention with respect to inspection of a plurality of large building roofs each having multiple sections. Other embodiments will be apparent to those skilled in the art given the benefit of this disclosure.

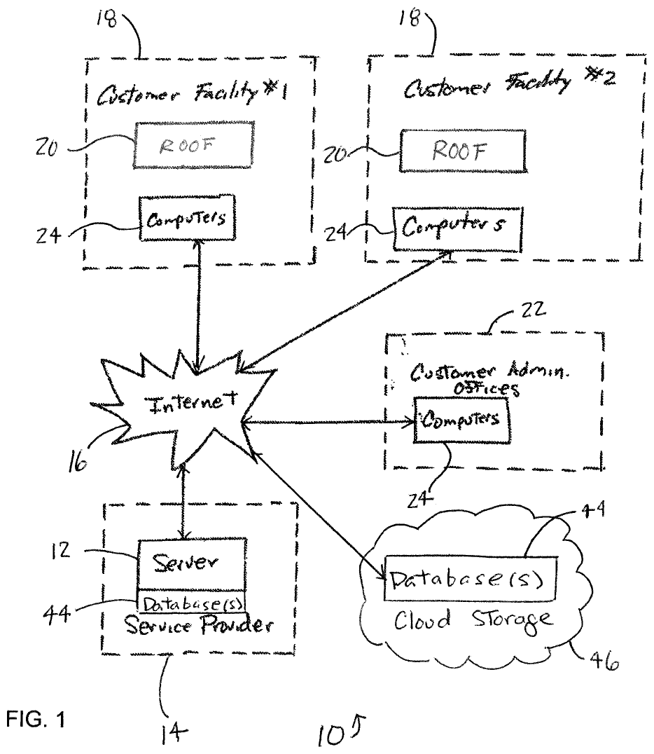

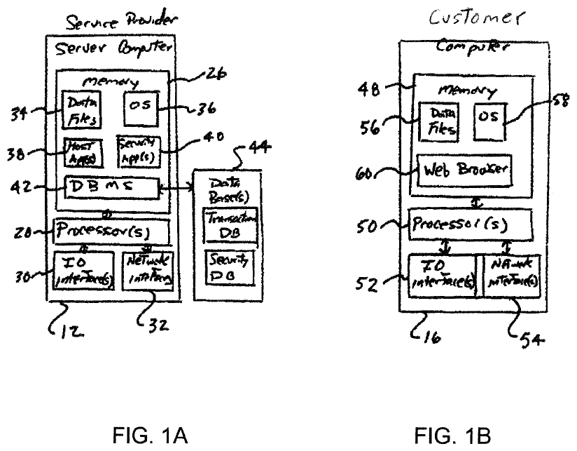

Referring now to the drawings, FIG. 1 shows a system for tracking, analyzing, and prioritizing building roof maintenance and repairs according to the present invention. The illustrated system 10 includes at least one server 12 programmed with computer software for tracking, analyzing, and prioritizing building roof maintenance and repairs according to the present invention. The illustrated server 12 is located at a service provider 14 and can be accessed by a customer via a communication system 16 as software as a service but alternatively can be located at any other suitable location such as, for example, cloud based, a customer computer or computer network, or the like. It is noted, for example, that the service provided could be eliminated and the software could reside on a server of a company having at least one facility. The illustrated system 10 also includes a plurality of customer facilities 18 each having at least one roof or at least a portion of a roof 20 that requires periodic maintenance and repair. Typically, each customer facility has a roof with multiple sections or portions that require periodic maintenance and repair. The illustrated system 10 also includes a customer administrative office 22. While the illustrated embodiment shows only two customer facilities 18 and one administrative office, it should be appreciated that a customer can have any other quantity of facilities 18 and/or administrative offices 22 and typically would have more than two facilities 18 with roofs 20 needing periodic repair. Each of the illustrated customer facilities 18 and the customer administrative office 22 has at least one customer computer 24 in communication with each other and the service provider server 12 via the communication system. 16.

The term “server” is used in the specification and claims to mean a computer configured to manage, store, send and process data 24-hours a day. The term “computer” is used in the specification and claims to mean any electronic device that can suitably communicate via a computer network including, but not limited to, desktop computers, laptop computers, notebook computers, tablet computers, smart phones, portable electronic devices or mobile devices, digital cameras, mp3 players, video game systems, messaging systems, video players, smart televisions, and the like. The terms “portable electronic device” and “mobile device” are used in the specification and claims to mean a handheld electronic device that utilizes rechargeable batteries as a power source and that can suitably communicate with event system server via the computer network including, but not limited to, smart phones, personal digital assistants (PDAs), mp3 or other music players, video game players, messaging systems, tablet computers, notebook computers, and the like.

The illustrated service provider server 12, and the illustrated customer computers 24 are in electronic communication with one another via the communication system 16. The illustrated communication system 16 is a computer network such as the Internet but any other suitable communication system can alternatively be utilized such as, for example, an intranet, any other type network of computers, and the like.

The illustrated service provider server or computer 12 includes memory 26, at least one processor or central processing units (CPU) 28 in communication with the memory 26, one or more input/output (IO) interfaces 30 in communication with the processor 28, and at least one network interface 32 in communication with the processor 28, all of which is configured to carry out the functions and steps described herein (best shown in FIG. 1A). The illustrated memory 26 stores data files 34, an operating system (OS) 36, host applications 38 for communications with web browsers and mobile applications, security applications 40 for limiting access to authorized users, and a database management system 42 for interfacing with databases 44 having stored information. It is noted that any other suitable information and/or software can be stored in the processor 28 and/or the memory 26. The illustrated databases 44 are separate from the service provider server or computer 12 but it is noted that the databases 44 can alternatively be integrated with the service provider server or computer 12. The illustrated databases 44 are located at the service provider 14 and/or a cloud location 46 but it is noted that the databases 44 can alternatively be located at any other suitable location and/or be of any other suitable type. The illustrated databases 44 include a transaction database and a security database but any other suitable types of databases can alternatively or additionally be utilized. The at least one processor 28 can be of any suitable type. The at least one IO interface 30 can be of any suitable type such as a keyboard, a mouse, a track ball, a touch pad, a camera, a speaker, a monitor, a printer, a modem, a disk drive and the like. The network interface 32 can be of any suitable type such as, for example, a network interface card, software simulating a network card, and the like. The illustrated processor 28 and memory 26 are programmed with computer software for facilitating the method of the present invention including providing a web portal for interfacing with the customer computers 24.

The illustrated service provider server or computer 12 is located at the service provider 14 and can be accessed by customers via the communication system 16. It is noted that while the illustrated software is provided by the service provider 14 as software as a service (SaaS), the software can alternatively be provided in other suitable manners. It is also noted that while the illustrated system 10 shows a single customer, it should be appreciated that the service provider 14 typically provides such SaaS services to a plurality of different users. It is further noted that the service provider server 12 is not necessarily physically located at physical facilities of the service provider 14. In many instances the system 10 is cloud based.

Each of the illustrated customer computers 24 includes memory 48, at least one processor or central processing units (CPU) 50 in communication with the memory 48, one or more input/output (IO) interfaces 52 in communication with the processor 50, and at least one network interface 54 in communication with the processor 50, all of which is configured to carry out the functions and steps described herein (best shown in FIG. 1B). The illustrated memory 48 stores data files 56, an operating system (OS) 58, and a web browser 60. It is noted that any other suitable information and/or software can be stored in the processor 50 and/or memory 48. The at least one processor 50 can be of any suitable type. The at least one IO interface 52 can be of any suitable type such as a keyboard, a mouse, a track ball, a touch pad, a camera, a speaker, a monitor, a printer, a modem, a disk drive and the like. The network interface 54 can be of any suitable type such as, for example, a network interface card, software simulating a network card, and the like. The illustrated processor 50 and memory 48 are programmed with the web browser 60 for communicating with the web portal of the service provider server 12 as described in more detail hereinafter.

Each illustrated customer computer 24 is located at the remote sites of the customer or user such as, for example, the illustrated facilities 18 of the customer or the administrative offices 22 of the customer but it is noted that the customer computer 24 can be located at any other suitable location such as the service provider location, and the like. It is noted that the customer computer 24 can be a desktop computer or a mobile computer.

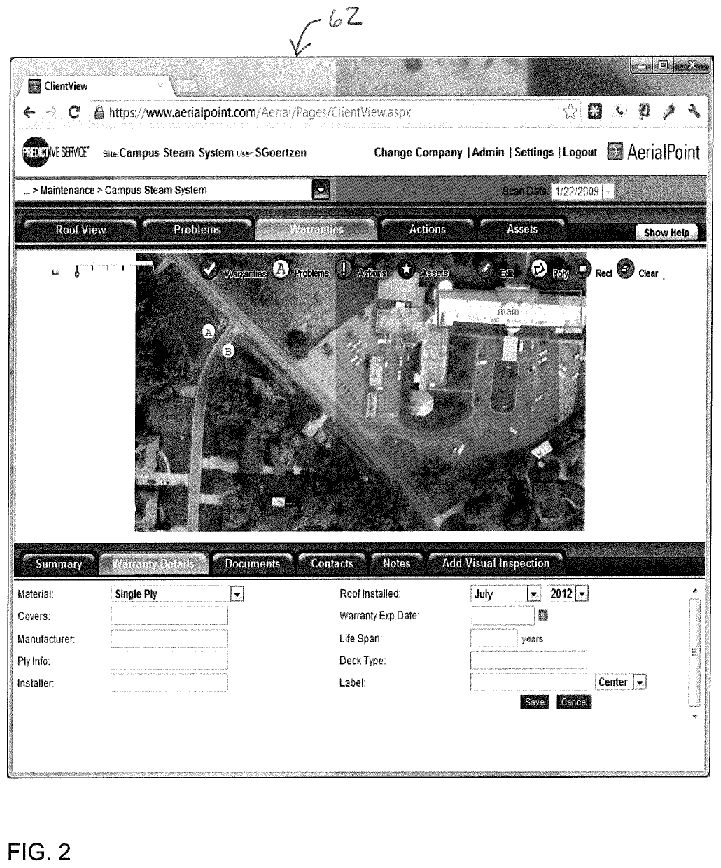

The illustrated system software or web platform resides at the service provider server 12 and is accessible to the customer via a web portal or dashboard on the customer computer 24. FIGS. 2 to 9 illustrate an exemplary method for tracking, analyzing, and prioritizing building roof maintenance and repairs according to the present invention according to the present invention and exemplary display screens on the customer's computer 24 during operation of the software for carrying out the method.

The illustrated method for tracking and analyzing maintenance and repair of a plurality of building roofs according to the present invention includes the steps of collecting information about the maintenance and repair of a plurality of building roofs. The user or customer enters identification information for each building roof such as a site name or location and also the total area for the building roof. The user or the service provider can preferably input an aerial image or photograph of the roof for reference. The user can input warranty information for each roof or section of a roof that has been repaired or had maintenance performed. The user can also input due dates for warranty visual inspections of the roofs as required by the warranties. After visual inspections, the user can input the details of a completed visual warranty inspection. It is noted that any other suitable information regarding the roofs can additionally be included if desired. The customer can then use this information to prioritize maintenance and repair of the roofs or sections of the roofs, determine if warranties apply to the roofs or sections of the roofs, and ensure that visual inspection requirements of warranties are carried out.

FIG. 2 illustrates an exemplary window 62 produced by the illustrated software that permits entry and viewing of warranty details for a particular building roof or section of a building roof 20. The illustrated window 62 permits the entry and viewing of a roofing material, coverage of the roofing material, the manufacturer of the building material, ply information, and the installer of the building roofing material. The illustrated window 62 permits the entry and viewing of the date the roof 20 was installed, the date the warranty expires, the life span of the roof 20, the deck type of the roof 20, and labels to be added to an aerial photograph of the building roof 20. It is noted that one or more warranties can be entered for each roof 20.

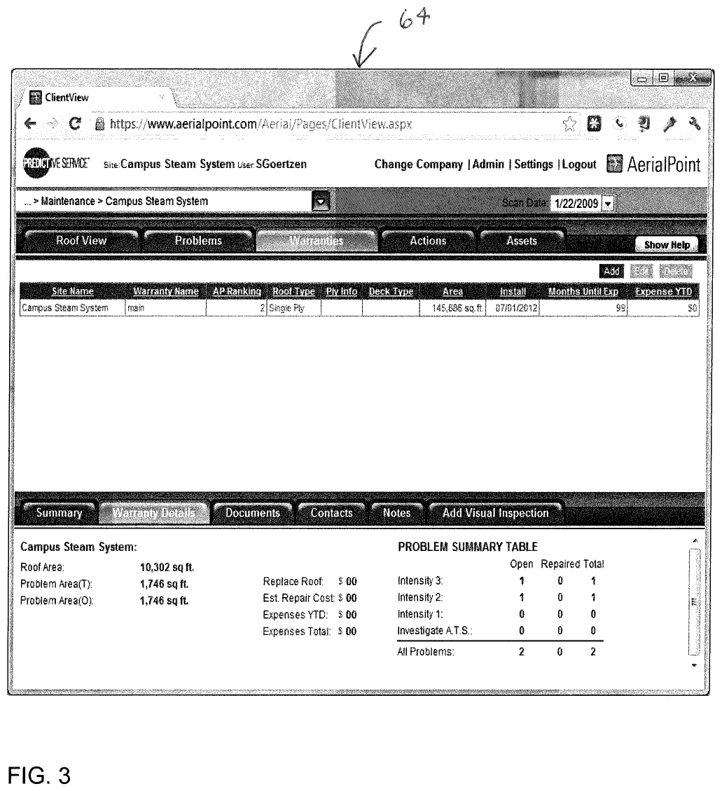

FIG. 3 illustrates an exemplary window 64 produced by the illustrated software that displays a list of building roofs 20 and associated warranty and other information as well as warranty details for a selected one of the roofs 20.

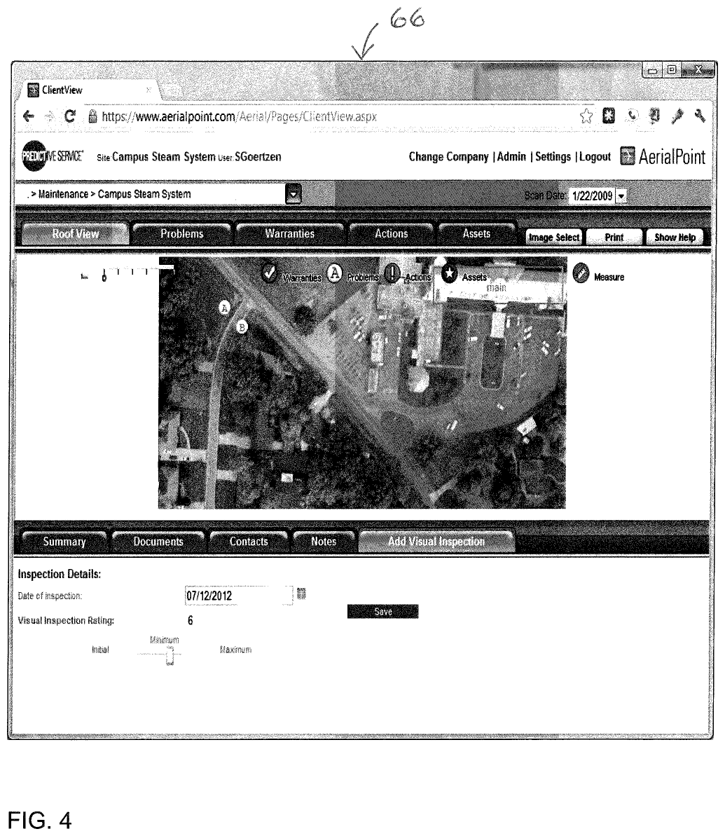

FIG. 4 illustrates an exemplary window 66 produced by the illustrated software that permits entry of details regarding visual inspections of the roofs 20 which may be required per the terms of the warranties. The illustrated window 66 permits the entry and saving of a date of inspection, and a visual inspection rating to indicate the condition of the roof 20 at the time of the visual inspection. The illustrated visual inspection rating is a numerical value selected from within a predetermined range of numbers, where a higher number indicates a worsening condition of the building roof 20. The illustrated range is from 1 to 10, where 1 indicate an initial or new condition and 10 indicates a maximum or worst possible damage condition, but any other suitable predetermined range can alternatively be utilized. The illustrated window 66 permits the visual inspection rating to be entered using an electronic slider via a mouse but any other suitable method of entry can alternatively be utilized.

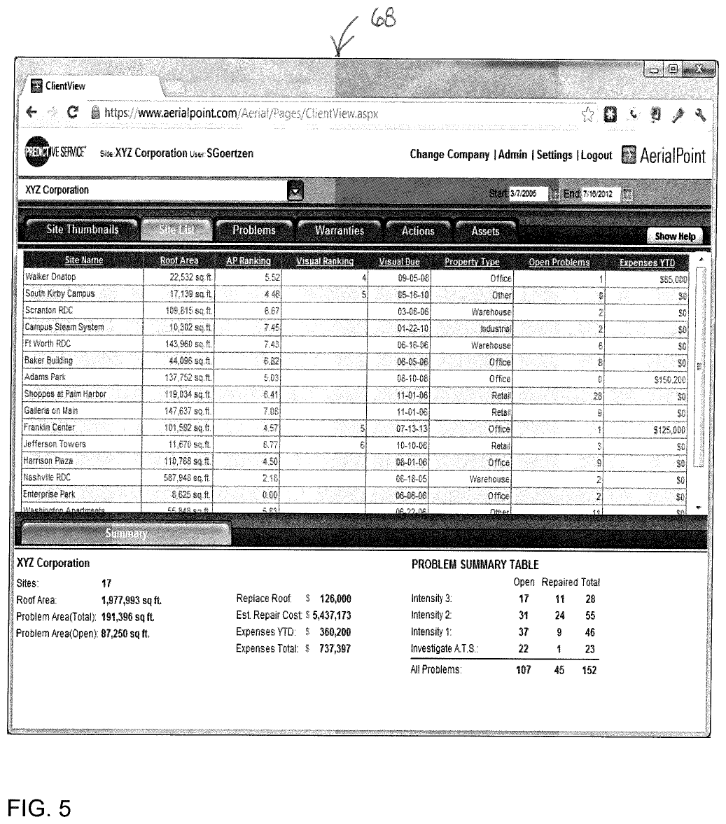

FIG. 5 illustrates an exemplary window 68 produced by the illustrated software that reports or displays information regarding a plurality of roofs 20 to the customer. The illustrated window 68 displays a site list which indicates, for each building roof, the site name, total roof area, condition ranking, visual ranking, due date for next visual inspection, property type, number of open problems, and the year to date expenses. Also displayed are summaries which aggregate information for the company including number of sites, total roof area of all buildings, total area of all problem areas of all building roofs 20, total area of all open items of all building roofs 20, the cost to replace roof 20, the estimated repair cost, the expenses to date for the year, and total expenses. Also displayed is a summary table which indicates the number of open, repaired and total roofs 20 for each intensity level and roofs 20 needing investigation. With this information, the customer can make informed decisions about scheduling maintenance and repair of a plurality of building roofs and/or sections of building roofs 20.

The illustrated window 68 also has other tabs including a Site Thumbnails tab which shows aerial photographs of the building roofs 20, a Problems tab which shows information about specific roof problems, a Warranties tab which shows warranty information regarding the building roofs 20 as discussed above, an Actions tab which shows actions to be taken related to the building roofs 20, and an Assets tab which shows information regarding company assets related to the building roofs 20.

The illustrated method for prioritizing maintenance and repair of building roofs 20 according to the present invention includes the step of electronically calculating a Condition Ranking or Area Problem Ranking (APR) for each building roof or section of a building roof 20. The illustrated Condition Rankings are numerical numbers that can be compared and used as an objective indicator to prioritize the order to which the roofs 20 should be repaired and/or maintained. The illustrated Condition Ranking is based on the amount of each roof 20 that has various levels or severity of problems. A predetermined plurality of problem levels is established ranging from no or minimal problems to severe problems. The illustrated Condition Ranking is based on three problem levels: level 1; level 2 which is more severe than level 1; and level 3 which is more severe than level 2. It is noted that any other suitable number of problem levels can alternatively be utilized.

Once the user or customer enters identification information for each building roof 20 such as a site name or location and also the total area for the building roof. The user or service provider inputs the area or percentage of the roof 20 which has level 3 problems, the area or percentages of the roof that has level 2 problems, and the area or percentage of the roof that has level 1 problems. The user then inputs an Area Intensity Weight which indicates whether the customer wants to put more emphasis in repairing large areas having problems or more emphasis on repairing high severity problems. In the illustrated embodiment, the Area Intensity Weight is a numeric value selected from within a predetermine range of numeric values. The illustrated range is from 1 to 10, where 1 indicates more emphasis should be placed on the intensity or severity of problems and 10 indicates more emphasis is should be placed on the area or amount of the roof having problems. In the illustrated embodiment, a selection of 5 for the Area Intensity Weight indicates that severity and size should be weighted equally. It is noted that any other suitable range or other type of weighting can alternatively be utilized.

The processor of the service provider calculates a Condition Ranking for each building roof or section of a building roof 20 that is separately entered by the user or service provider. The illustrated Condition Ranking is designed to be a numeric value within the predetermined range of 1 and 10 that indicates the overall condition of the building roof or section of building roof. It is noted that any other suitable numeric range or other suitable range can alternatively be utilized. Once calculated, the Condition Ranking for each building roof or section of building roof 20 is provided by the service provider for viewing by the customer. The customer can then compare the Condition Ranking of different building roofs and/or sections of roofs 20 to prioritize the maintenance and repair of the roofs and/or sections of roofs 20, that is, to determine the order and timing of the maintenance and repair of the roofs and/or sections of roofs 20.

The formula for calculating Condition Ranking or Area Problem Ranking (APR) in the illustrated method for prioritizing building roof maintenance and repairs is:

$$APR = \frac{Log ( Ψ , 2 ) + LG}{LV}$$

where LG is a Log Constant equal to 4.47, LV is a Level Constant equal to 1.111385619; and ψ is a variable based at least partly on the severity and scope of the problems of the roof or segment of the roof 20. It is noted that any other suitable formula for the Condition Ranking can alternatively be utilized.

The formula for calculating ψ in the illustrated method for prioritizing building roof maintenance and repairs is:

$$Ψ = \frac{3 \times AP 3 + ( ( 1.9 + .1 W ) \times AP 2 ) + ( ( .8 + .2 W ) \times AP 1 )}{.03 AT}$$

where AP3 is the area of the roof having level 3 problems (in square feet), AP2 is the area of the roof having level 2 problems (in square feet), AP1 is the area of the roof having level 1 problems (in square feet), W is the Area intensity Weight (a number between 1 and 10), and AT is the total area of the roof (in square feet). However, if ψ is less than 0.01, ψ is automatically set to be equal to 0.01. It is noted that any other suitable formula for the Condition Ranking can alternatively be utilized.

As seen in FIG. 5, the illustrated software that reports or displays the calculated Condition Rankings to the customer. The illustrated window 68 displays a site list which indicates, for each building roof, the site name, total roof area, condition ranking, visual ranking, due date for next visual inspection, property type, number of open problems and the year to date expenses. Also displayed are summaries which aggregate information for the company including number of sites, total roof area of all buildings, total area of all problem areas of all building roofs, total area of all open items of all building roofs, the cost to replace roof, the estimated repair cost, the expenses to date for the year, and total expenses. Also displayed is a summary table which indicates the number of open, repaired and total roofs for each intensity level and roofs needing investigation. With this information, the customer can make informed decisions about scheduling maintenance and repair of a plurality of building roofs 20.

From the forgoing disclosure and detailed description of certain preferred embodiments, it is apparent that an objective comparison of the condition of roofs can be determined and utilized in order to prioritize maintenance and repair of a plurality of building roofs and sections of roofs. Constants are used so that the calculation can be automated with some customer input. The customer receives accurate, consistent reporting, even from multiple facility locations from which informed roof maintenance and repair decisions can be made. The illustrated software can enable a customer to achieve goals of energy savings, cost savings, or just to prevent roof failures. The illustrated software provides numerous benefits to clients of any size or any industry in any part of the world.

From the foregoing disclosure and detailed description of certain preferred embodiments, it is also apparent that various modifications, additions and other alternative embodiments are possible without departing from the true scope and spirit of the present invention. The embodiments discussed were chosen and described to provide the best illustration of the principles of the present invention and its practical application to thereby enable one of ordinary skill in the art to utilize the invention in various embodiments and with various modifications as are suited to the particular use contemplated. All such modifications and variations are within the scope of the present invention as determined by the appended claims when interpreted in accordance with the benefit to which they are fairly, legally, and equitably entitled.

What is claimed is:

1. A computer implemented method for prioritizing maintenance and repairs of building roofs, comprising the steps of:
electronically receiving total area and problem information associated with each of a plurality of building roofs;
wherein the problem information includes information regarding scope of problems and severity of problems;
electronically calculating a condition ranking for each of the building roofs based at least partly on the total area and the problem information;
wherein the condition ranking is a numeric value; and
electronically providing the condition ranking for each of the building roofs to a user for viewing on an electronic display so that repair and maintenance of the roofs can be prioritized at least partly using the condition rankings.

2. The computer implemented method according to claim 1, wherein the numeric value is within a predetermined range.

3. The computer implemented method according to claim 2, wherein the predetermined range is 1 to 10.

4. The computer implemented method according to claim 1, wherein the problem information includes a problem level selected from a predetermined plurality of problem levels ranging from no or minimal problems to severe problems, and the amount of the roof that has each of the plurality of problem levels.

5. The computer implemented method according to claim 1, wherein the formula for calculating the condition ranking (APR) is:
$$APR = \frac{Log ( Ψ , 2 ) + LG}{LV}$$
where LG is a Log Constant equal to 4.47, LV is a Level Constant equal to 1.111385619; and ψ is a variable based at least in part on the problem information.

6. The computer implemented method according to claim 5, wherein the formula for calculating □ in the illustrated method for prioritizing building roof maintenance and repairs is:
$$Ψ = \frac{3 \times AP 3 + ( ( 1.9 + .1 W ) \times AP 2 ) + ( ( .8 + .2 W ) \times AP 1 )}{.03 AT}$$
where AP3 is the area of the roof having level 3 problems (in square feet), AP2 is the area of the roof having level 2 problems (in square feet), AP1 is the area of the roof having level 1 problems (in square feet), W is the Area intensity Weight (a number between 1 and 10), and AT is the total area of the roof (in square feet), and wherein, if ψ is less than 0.01, ψ is automatically set to be equal to 0.01.

7. A system for prioritizing maintenance and repairs of building roofs comprising:
a processor and memory configured to carry out the steps of:
electronically receiving total area and problem information associated with each of a plurality of building roofs;
wherein the problem information includes information regarding scope of problems and severity of problems;
electronically calculating a condition ranking for each of the building roofs based at least partly on the total area and the problem information;
wherein the condition ranking is a numeric value; and
electronically providing the condition ranking for each of the building roofs to a user for viewing on an electronic display so that repair and maintenance of the roofs can be prioritized at least partly using the condition rankings.

8. The system according to claim 7, wherein the numeric value is within a predetermined range.

9. The system according to claim 8, wherein the predetermined range is 1 to 10.

10. The system according to claim 7, wherein the problem information includes a problem level selected from a predetermined plurality of problem levels ranging from no or minimal problems to severe problems, and the amount of the roof that has each of the plurality of problem levels.

11. The system according to claim 7, wherein the formula for calculating the condition ranking (APR) is:
$$APR = \frac{Log ( Ψ , 2 ) + LG}{LV}$$
where LG is a Log Constant equal to 4.47, LV is a Level Constant equal to 1.111385619; and ψ is a variable based at least in part on the problem information.

12. The system according to claim 11, wherein the formula for calculating □ in the illustrated method for prioritizing building roof maintenance and repairs is:
$$Ψ = \frac{3 \times AP 3 + ( ( 1.9 + .1 W ) \times AP 2 ) + ( ( .8 + .2 W ) \times AP 1 )}{.03 AT}$$
where AP3 is the area of the roof having level 3 problems (in square feet), AP2 is the area of the roof having level 2 problems (in square feet), AP1 is the area of the roof having level 1 problems (in square feet), W is the Area intensity Weight (a number between 1 and 10), and AT is the total area of the roof (in square feet), and wherein, if ψ is less than 0.01, ψ is automatically set to be equal to 0.01.

13. A computer readable medium containing program instructions for:
electronically receiving total area and problem information associated with each of a plurality of building roofs;
wherein the problem information includes information regarding scope of problems and severity of problems;
electronically calculating a condition ranking for each of the building roofs based at least partly on the total area and the problem information;
wherein the condition ranking is a numeric value; and
electronically providing the condition ranking for each of the building roofs to a user for viewing on an electronic display so that repair and maintenance of the roofs can be prioritized at least partly using the condition rankings.

14. The computer readable medium according to claim 13, wherein the numeric value is within a predetermined range.

15. The computer readable medium according to claim 14, wherein the predetermined range is 1 to 10.

16. The computer readable medium according to claim 13, wherein the problem information includes a problem level selected from a predetermined plurality of problem levels ranging from no or minimal problems to severe problems, and the amount of the roof that has each of the plurality of problem levels.

17. The computer readable medium according to claim 13, wherein the formula for calculating the condition ranking (APR) is:
$$APR = \frac{Log ( Ψ , 2 ) + LG}{LV}$$
where LG is a Log Constant equal to 4.47, LV is a Level Constant equal to 1.111385619; and ψ is a variable based at least in part on the problem information.

18. The computer readable medium according to claim 17, wherein the formula for calculating □ in the illustrated method for prioritizing building roof maintenance and repairs is:
$$Ψ = \frac{3 \times AP 3 + ( ( 1.9 + .1 W ) \times AP 2 ) + ( ( .8 + .2 W ) \times AP 1 )}{.03 AT}$$
where AP3 is the area of the roof having level 3 problems (in square feet), AP2 is the area of the roof having level 2 problems (in square feet), AP1 is the area of the roof having level 1 problems (in square feet), W is the Area intensity Weight (a number between 1 and 10), and AT is the total area of the roof (in square feet), and wherein, if ψ is less than 0.01, ψ is automatically set to be equal to 0.01.
